(19) United States
(12) Patent Application Publication
(10) Pub. No.: US 2015/0299930 A1
(43) Pub. Date: Oct. 22, 2015

(54) LAUNDRY TREATING APPARATUS

(71) Applicant: LG ELECTRONICS INC., Seoul (KR)

(72) Inventors: Jinho YANG, Seoul (KR); Youngsoo KIM, Seoul (KR)

(21) Appl. No.: 14/689,305

(22) Filed: Apr. 17, 2015

(30) Foreign Application Priority Data
Apr. 17, 2014 (KR) 10-2014-0046235

(51) Int. Cl. D06F 39/00; F21V 23/00; F21V 33/00

(52) U.S. Cl. CPC D06F 39/005; F21V 33/0044; F21V 23/005; F21Y 2101/02

(57) ABSTRACT

A laundry treating apparatus is described. The laundry treating apparatus includes a rotary control. The laundry treating apparatus further includes a control panel body that includes a rotary control hole in which the rotary control is rotatably positioned, and at least one indicator configured to indicate a course capable of being selected by the rotary control. The laundry treating apparatus further includes a plurality of light emitting diodes (LEDs) arranged on a printed circuit board (PCB), a number of the plurality of LEDs being larger than a number of the at least one indicator. The laundry treating apparatus further includes a window through which light emitted from the plurality of LEDs passes.

### CROSS-REFERENCE TO RELATED APPLICATION

This application claims the priority benefit of Korean Patent Application No. 10-2014-0046235, filed on Apr. 17, 2014 in the Korean Intellectual Property Office, the disclosure of which is incorporated herein by reference.

### FIELD

This application relates to a laundry treating apparatus and a method of controlling the same, and more particularly to a laundry treating apparatus that is provided with a plurality of LEDs and a method of controlling the same.

### BACKGROUND

Laundry treating apparatuses generally refer to apparatuses that are constructed to apply mechanical action generated by electric power to clothing and bedclothes (hereinafter, referred to as “laundry”) so as to remove contaminants from the laundry or to supply hot air to the laundry so as to dry the laundry.

The laundry treating apparatus may include a control panel capable of representing information of the apparatus and allowing commands for operation of the apparatus to be input to the apparatus.

The control panel may be mounted on an upper portion of the laundry treating apparatus. A user may input commands for operation of the apparatus through at least one manipulation unit provided at the control panel while viewing various information displayed on the control panel.

The control panel may be provided with a tap switch that is switched by a button, a rotary switch that is operated by a rotary knob, and the like.

When the control panel includes a rotary switch, the control panel may be provided with a rotary knob for manipulating the rotary switch.

### SUMMARY

According to an innovative aspect of the subject matter described in this application, a laundry treating apparatus includes a rotary control; a control panel body that includes a rotary control hole in which the rotary control is rotatably positioned, and at least one indicator configured to indicate a course capable of being selected by the rotary control; a plurality of light emitting diodes (LEDs) arranged on a printed circuit board (PCB), a number of the plurality of LEDs being larger than a number of the at least one indicator; and a window through which light emitted from the plurality of LEDs passes, where the plurality of LEDs includes a first LED group including at least one LED that is configured to radiate light to an indicating region of the window corresponding to the at least one indicator, and a second LED group including at least one LED that is configured to radiate light to a region of the window that is outside of the indicating region of the window.

The laundry treating apparatus may include one or more of the following optional features. The plurality of LEDs are spaced apart from each other at regular intervals in a circular pattern. The rotary control is a rotary knob and where the first LED group and the second LED group are alternately located on the PCB in a clockwise or counterclockwise direction about a rotating central shaft of the rotary knob. The first LED group includes a first left LED group that is configured to radiate light to a left region of the window located at a left side of the rotary control; and a first right LED group that is configured to radiate light to a right region of the window located at a right side of the rotary control.

The second LED group includes a second upper LED group that is configured to radiate light to an upper region of the window located above the rotary control, and a second lower LED group that is configured to radiate light to a lower region of the window located below the rotary control. The first LED group and the second LED group radiate light in a first lighting pattern in response to a power supply command being input. The second LED group is maintained in an off state after radiating light in the first lighting pattern. Only an LED of the first LED group corresponding to a predetermined course is maintained in an on state after radiating light in the first lighting pattern.

The second LED group is maintained in an off state during rotation of the rotary control. A plurality of LEDs of the first LED group are selectively turned on during rotation of the rotary control. The plurality of LEDs are controlled to radiate light in an arcuate lighting pattern that rotates around the rotary control in response to a power supply command being input. The plurality of LEDs are sequentially turned on in a clockwise or counterclockwise direction in response to a power supply command being input. The plurality of LEDs are maintained in an on state for a predetermined period of time after all of the plurality of LEDs are turned on. After the predetermined period of time has elapsed, all of the plurality of LEDs are turned off except a predetermined LED is maintained in an on state.

According to another innovative aspect of the subject matter described in this application, a method of controlling laundry treating apparatus includes the actions of receiving a power supply command; in response to receiving the power supply command, controlling a plurality of LEDs to radiate light in a first lighting pattern representing the power supply command, a number of the plurality of LEDs being larger than a number of a plurality of indicators located on a control panel body; receiving a course selection command; and in response to receiving the course selection command, selectively turning on one or more LEDs of a first set of the plurality of LEDs to radiate light to an indicating region in a second lighting pattern, and maintaining a second set of the plurality of LEDs in an off state, the second set of the plurality of LEDs are different from the first set of the plurality of LEDs and radiate light to a region other than the indicating region.

The method may include one or more of the following optional features. The first lighting pattern includes an arcuate lighting pattern rotating around a rotary control. The action of controlling the plurality of LEDs to radiate light in the first lighting pattern includes sequentially turning on the some LEDs of the plurality of LEDs in a clockwise or counterclockwise direction to radiate light in an arcuate lighting pattern around a rotary control. The actions further include in response to receiving the power supply command, rotating the arcuate lighting pattern around the rotary control.

The arcuate lighting pattern has a leading end at which the plurality of LEDs are sequentially turned on in a clockwise or counterclockwise direction and a posterior end at which the plurality of LEDs are sequentially turned off in the clockwise or counterclockwise direction. The actions further include maintaining a size of the arcuate lighting pattern. The actions further include determining that a predetermined LED of the plurality of LEDs is turned on a predetermined number of times; and based on determining that the predetermined LED is turned on the predetermined number of times, sequentially turning off the plurality of LEDs that are illuminated other than the predetermined LED. The action of controlling the plurality of LEDs to radiate light in the first lighting pattern includes sequentially turning on the plurality of LEDs in a clockwise or counterclockwise direction.

The action of controlling the plurality of LEDs to radiate light in the first lighting pattern includes sequentially turning on the plurality of LEDs in a clockwise or counterclockwise direction; and maintaining the plurality of LEDs in an activated state for a predetermined period of time after all of the plurality of LEDs have been turned on. The action of controlling the plurality of LEDs to radiate light in the first lighting pattern further includes, after the predetermined period of time has elapsed, turning off all of the plurality of LEDs. The action of controlling the plurality of LEDs to radiate light in the first lighting pattern further includes turning on a predetermined LED.

It is an object of the subject matter described in this application to provide a laundry treating apparatus capable of creating a lighting pattern having a continuous shape such as an arcuate shape and an annular shape at an area around a rotary knob.

It is another object of the subject matter described in this application to provide a method of controlling a laundry treating apparatus in which a plurality of LEDs represents input of a power supply command of the laundry treating apparatus.

### BRIEF DESCRIPTION OF THE DRAWINGS

FIG. 1 is a perspective view of a first laundry treating apparatus.

FIG. 2 is an exploded perspective view of a control panel of the first laundry treating apparatus.

FIG. 3 is an exploded perspective view of a control panel of the first laundry treating apparatus.

FIG. 4 is a longitudinal sectional view of part of a control panel of the first laundry treating apparatus.

FIG. 5 is a transverse sectional view of part of a control panel of the first laundry treating apparatus.

FIG. 6 is an enlarged front view of a plurality of LEDs of the first laundry treating apparatus.

FIG. 7 is a flowchart of a first method of controlling the laundry treating apparatus.

FIG. 8 illustrates a plurality of LEDs when the first laundry treating apparatus performs a first procedure and displays a first lighting pattern.

FIG. 9 illustrates a control panel when the first laundry treating apparatus performs the first procedure and displays the first lighting pattern.

FIG. 10 illustrates a plurality of LEDs when the first laundry treating apparatus performs a second procedure and displays the first lighting pattern.

FIG. 11 illustrates a control panel when the first laundry treating apparatus performs the second procedure and displays the first lighting pattern.

FIG. 12 illustrates a plurality of LEDs when the first laundry treating apparatus performs a third procedure and displays the first lighting pattern.

FIG. 13 illustrates a control panel when the first laundry treating apparatus performs the third procedure and displays the first lighting pattern.

FIG. 14 illustrates a plurality of LEDs when the first laundry treating apparatus creates a second lighting pattern.

FIG. 15 illustrates a control panel when the first laundry treating apparatus creates the second lighting pattern.

FIG. 16 illustrates a plurality of LEDs when a power supply command is input to a second laundry treating apparatus.

FIG. 17 illustrates lighting patterns created on the control panel when the power supply command is input to the second laundry treating apparatus.

FIG. 18 is a flowchart of a second method of controlling the second laundry treating apparatus.

FIG. 19 illustrates the plurality of LEDs when a power supply command is input to a third laundry treating apparatus.

FIG. 20 illustrates a lighting pattern created on a window when a power supply command is input to a third laundry treating apparatus.

FIG. 21 is a flowchart of a third method of controlling the third laundry treating apparatus.

### DETAILED DESCRIPTION

A laundry treating apparatus as described in the present disclosure may be applied to any of a top loading type laundry treating apparatus that includes a laundry port formed at the top of a cabinet that allows laundry to be put into or taken out therethrough, and a front loading type laundry treating apparatus that includes a laundry port formed at a front or side surface of a cabinet. In a subsequent description, a front loading type laundry treating apparatus will be described by way of example.

The laundry treating apparatus should be considered to include all apparatuses for treating laundry. More specifically, the laundry treating apparatus may include a washing machine to remove contaminants from laundry using washing water, a dryer to remove moisture from laundry so as to dehydrate the laundry, and a combination washer/dryer having both washing and drying functions.

The dryer may include a drum dryer that is constructed to supply hot air into a rotatable drum so as to dry laundry, and a cabinet type dryer (refresher) that is constructed to supply hot air into a drying space accommodating laundry.

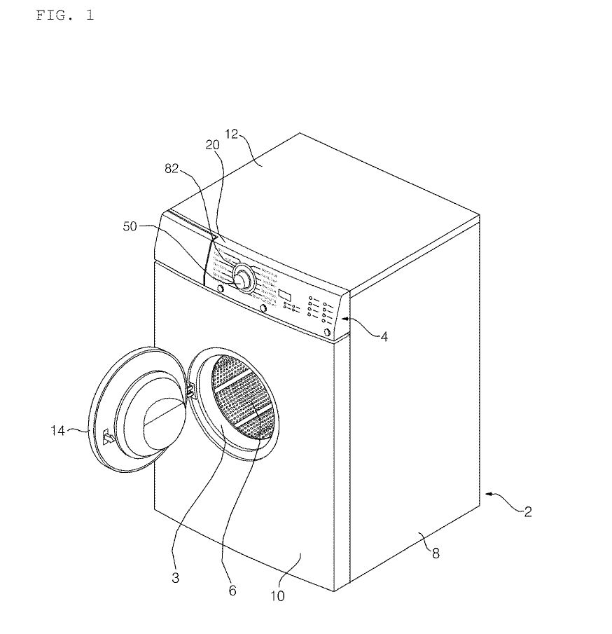

FIG. 1 illustrates an example laundry treating apparatus.

In some implementations, the laundry treating apparatus may include a cabinet 2, and a control panel 4 provided at the cabinet 2.

The cabinet 2 may be a case defining an external appearance of the laundry treating apparatus. The cabinet 2 may be provided with a laundry port 3 through which laundry is put into or taken out of the cabinet 2. The cabinet 2 may be provided therein with a tub for containing washing water. The tub may be provided therein with a drum 6 that is rotatable therein. The cabinet 2 may be provided therein with a motor for rotating the drum 6. If the laundry treating apparatus is a dryer, the tub for containing washing water may not be provided in the cabinet 2, and the drum 6 may be rotatably supported by a support installed in the cabinet 2.

The cabinet 2 may be constructed by bending a single member several times or by coupling a plurality of members to one another. The cabinet 2 may include a base pan, a cabinet body 8 installed on the base pan and having a space for accommodating the tub, a cabinet cover 10 disposed in front of the cabinet body 8 and including the laundry port 3, and a top cover 12 disposed on the cabinet body 8. The cabinet body 8 may be constructed y a single member, and may also be constructed by a plurality of members. The cabinet body 8 may include a left cover disposed on the left side of the base pan, a right cover disposed on the right side of the base pan, and a rear cover disposed on the rear side of the base pan. The cabinet 2 may be constructed by one of various combinations of a plurality of members and may be configured into various modifications.

The cabinet 2 may be provided with a door 14 for opening or closing the laundry port 30. The door 14 may be hinged to the cabinet 2 to open or close the laundry port 3, and may also be slidably coupled to the cabinet 2 to open or close the laundry port 3. The door 14 may be hinged to the cabinet 2 by means of a hinge element, and thus may be swung about the hinge element to open or close the laundry port 3.

The control panel 4 may include a manipulation unit. The control panel 4 may include a display unit for displaying information of the laundry treating apparatus. The control panel 4 may include both the manipulation unit and the display unit. The control panel 4 may be disposed on the cabinet cover 10. The control panel 4 may be disposed on a front surface of the cabinet 2, and may define a portion of the external appearance of the laundry treating apparatus.

The control panel 4 may include a control panel body 20 defining an exterior appearance thereof. The control panel body 20 may be disposed on the cabinet cover 10. The control panel body 20 may be provided with the manipulation unit for enabling user manipulation and the display unit for displaying various information of the laundry treating apparatus to a user.

The control panel 4 may include a rotary knob 50 adapted to be gripped by user fingers to allow user manipulation. The rotary knob 50 may be installed to be rotated by a user in order to select one of various treatment courses of the laundry treating apparatus.

The control panel 4 may further include a window 82 disposed to surround a circumference of the rotary knob 50. The laundry treating apparatus may radiate light to the window 82. A user may recognize a course of the laundry treating apparatus by viewing the light radiated to the window 82.

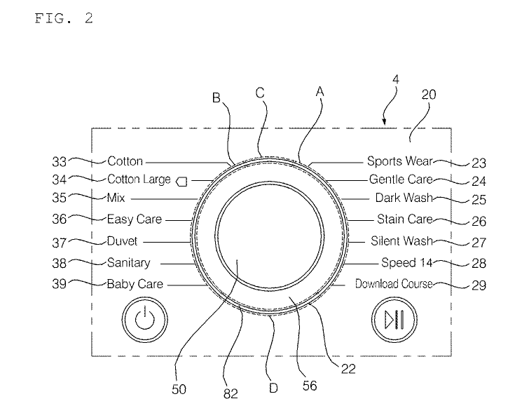

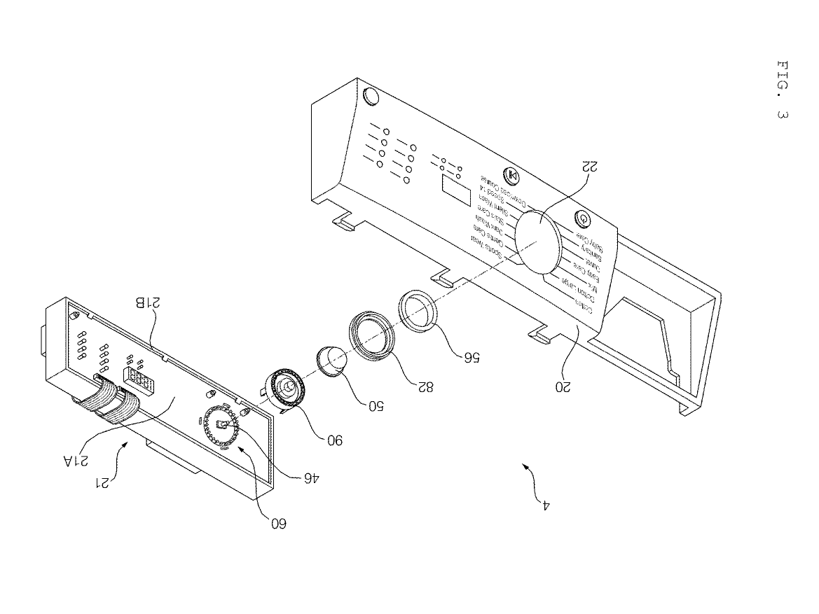

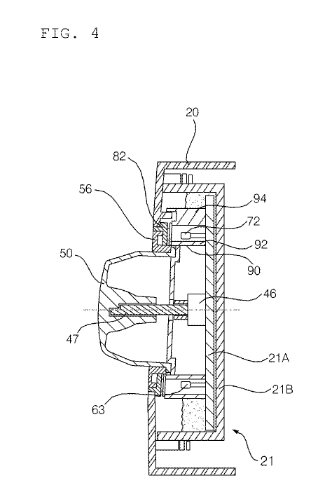

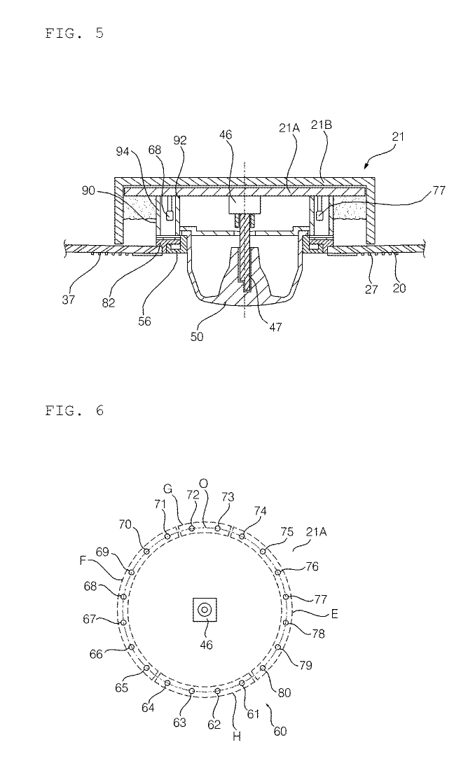

FIGS. 2-6 illustrate example views of a control panel of an example laundry treating apparatus.

The control panel 4 may include a printed circuit board (PCB) assembly 21 installed in the control panel body 20. The PCB assembly 21 may include a PCB 21A, and a PCB mount 21B at which the PCB 21A is installed. The PCB mount 21B may be mounted on the control panel body 20 by means of a fastening element such as a screw. The control panel 4 may include the manipulation unit that enables a user to manipulate the laundry treating apparatus. The PCB assembly 21 may include a rotary switch 46. The rotary switch 46 may include a rotating central shaft 47 to which the rotary knob 50 is joined. Upon rotation of the rotating central shaft 47, the rotating central shaft 47 may rotate with the rotary knob 50. The rotary switch 46 may include a rotary encoder in which a plurality of switching circuits are provided. The rotary switch 46 may detect rotation of the rotating central shaft 47. The PCB assembly 21 may further include a tap switch and a touch switch. The control panel 4 may include a display component for displaying information of the laundry treating apparatus. The PCB assembly 21 may include a light source such as an LED.

The laundry treating apparatus may include a control panel body 20, the rotary knob 50, a plurality of LEDs 60, and the window 82, all of which may constitute the control panel 4.

The control panel body 20 may include a rotary knob hole 22 in which the rotary knob 50 is rotatably disposed. The rotary knob hole 22 may be formed to be larger than the rotary knob 50. The rotary knob hole 22 may be formed into a circular shape.

As illustrated in FIG. 2, the control panel body 20 may include one or more indicators 23-29 and 33-39 for displaying treatment courses which may be selected by the rotary knob 50.

The indicators 23-29 and 33-39 constitute a course display unit that represents various courses (washing programs) of the laundry treating apparatus as numerals, symbols, characters and the like Each of the indicators 23-29 and 33-39 may be constituted by embossed or engraved lettering formed on the control panel body 20 or a coating applied to the control panel body 20. In addition, the indicators 23-29 and 33-39 may be provided on the control panel body through various technologies other than printing and coating. The indicators 23-29 and 33-39 may include at least two indicators, and the at least two indicators may be disposed around the rotary knob hole 22. The indicators 23-29 and 33-39 may include a plurality of indicators formed at the control panel body 20. A user may recognize a treatment course of the laundry treating apparatus by observing the plurality of indicators 23-29 and 33-39. Furthermore, a user may select a desired course among the plurality of treatment courses by rotating the rotary knob 50.

The laundry treating apparatus may radiate light toward an area near one of the plurality of indicators 23-29 and 33-39 selected by a user, and, as such, a user may recognize the indicator closest to the area to which the light is radiated. Each of the plurality of indicators 23-29 and 33-39 may include characters representing the corresponding course. Each of the plurality of indicators 23-29 and 33-39 may further include a line between the rotary knob hole 22 and the characters. The laundry treating apparatus may radiate light to an area near one of lines associated with the plurality of indicators 23-29 and 33-39. At this time, a user may recognize the indicator associated with the line closest to the light radiated from the laundry treating apparatus.

In other words, a user may recognize, among the plurality of indicators 23-29 and 33-39, the indicator corresponding to the area to which light is radiated.

When the laundry treating apparatus has, for example, 14 treatment courses, the indicators 23-29 and 33-39 may include 14 indicators formed at the control panel body 20. In this case, the laundry treating apparatus may selectively make 14 areas bright so as to represent the treatment courses.

The indicators 23-29 and 33-39 may include left indicators 23-29 positioned at the left side of the rotary knob hole 22, and right indicators 33-39 positioned at the right side of the rotary knob hole 22.

The plurality of left indicators 23-29 may be positioned together at the left side of the rotary knob hole 22, and may be spaced apart from one another in the vertical direction.

The plurality of right indicators 33-39 may be positioned together at the right side of the rotary knob hole 22, and may be spaced apart from one another in the vertical direction.

The rotary knob 50, which serves as a handle capable of being manipulated by a user, may be connected to the rotary switch 46. The rotary knob 50 may be manipulated by a user in a state of being partially disposed in the rotary knob hole 22. The rotary knob 50 may have a front portion disposed in front of the rotary knob hole 22 and thus may be exposed to the outside of the laundry treating apparatus. The rotary knob 50 may have a rear portion disposed in the rear of the rotary knob hole 22, that is, in the control panel body 20. When a front portion of the rotary knob 50 is gripped and rotated by a user, the rotary switch 46 may detect a rotating angle of the rotary knob 50, and the laundry treating apparatus may execute the course selected by rotation of the rotary knob 50.

The laundry treating apparatus may further include a knob decorative member 56 surrounding an outer circumferential surface of the rotary knob 50. The knob decorative member 56 may have an internal diameter larger than an external diameter of the rotary knob 50. The knob decorative member 56 may have an external diameter equal to or smaller than a diameter of the rotary knob hole 22. The knob decorative member 56 may be coupled to the window 82.

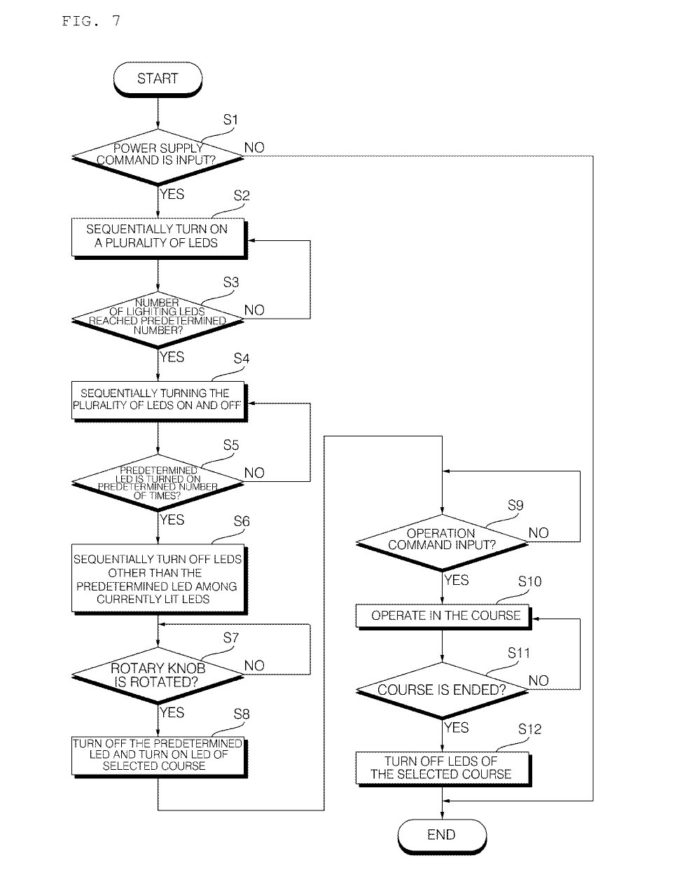

As illustrated in FIG. 6, the plurality of LEDs 60 may be arranged on the PCB 21A in a circular shape. The number of the plurality of LEDs 60 may be larger than that of the indicators 23-29 and 33-39. The plurality of LEDs 60 may be disposed around the rotary switch 46 of the PCB 21A. The plurality of LEDs 60 may be sequentially disposed along an imaginary circle O around the rotary switch 46. The plurality of LEDs 60 may be disposed to surround the rotary switch 46. The plurality of LEDs 60 may be spaced apart from one another along the imaginary circle O. The plurality of LEDs 60 may be positioned spaced apart from one another along the imaginary circle O at substantially regular intervals. The plurality of LEDs 60 may be spaced apart from one another along the imaginary circle O in a clockwise or counterclockwise direction.

The plurality of LEDs 60 may include course LEDs 65-71 and 74-80, and non-course LEDs 61-64, 72, and 73. The course LEDs 65-71 and 74-80 may be one or more LEDs that light up while the laundry treating apparatus displays a treatment course. The non-course LEDs 61-64, 72, and 73 may be one or more LEDs that do not light up while the laundry treating apparatus displays a treatment course.

Similarly to the indicators 23-29 and 33-39, the one or more course LEDs 65-71 and 74-80 may also include a plurality of LEDs. The number of the course LEDs 65-71 and 74-80 may be the same as that of the indicators 23-29 and 33-39. Each of the course LEDs 65-71 and 74-80 may be assigned one indicator. For example, when 14 indicators are provided, the course LEDs may include 14 course LEDs.

Upon input of a power supply command, the course LEDs 65-71 and 74-80 may be turned on or off in accordance with preset control. Upon input of a power supply command, the first LEDs 65-71 and 74-80 may be turned on or off so as to create a first lighting pattern representing power input. A plurality of LEDs among the course LEDs 65-71 and 74-80 may be selectively turned on during a period for which the laundry treating apparatus displays a treatment course.

In some implementations, the number of the non-course LEDs 61-64, 72, and 73 provided at the PCB 21A may be one or more, or two or more. The number of the non-course LEDs 61-64, 72, and 73 may be less than the number of the indicators 23-29 and 33-39. For example, when 14 indicators are provided, the course LEDs may include 6 course LEDs.

Upon input of a power supply command, the non-course LEDs 61-64, 72, and 73 may be turned on or off in accordance with preset control. Upon input of a power supply command, the non-course LEDs 61-64, 72, and 73 may be turned on or off so as to create the lighting pattern representing power input.

The non-course LEDs 61-64, 72, and 73 may be controlled together with the course LEDs 65-71 and 74-80 while the laundry treating apparatus creates the first lighting pattern representing input of the power supply command.

Upon input of a power supply command, the laundry treating apparatus may create the first lighting pattern representing input of the power supply command during a predetermined period of time. The course LEDs course LEDs 65-71 and 74-80 and the non-course LEDs 61-64, 72, and 73 may be controlled together to create the first lighting pattern during the predetermined period of time.

The first lighting pattern may include an arcuate lighting pattern rotating around the rotary knob 50. Upon input of a power supply command, the plurality of LEDs 60 may be controlled such that the arcuate lighting pattern rotates around the rotary knob 50. The course LEDs 65-71 and 74-80 and the non-course LEDs 61-64, 72, and 73 of the plurality of LEDs 60 are controlled together to create the arcuate lighting pattern rotating around the rotary knob 50.

When the predetermined period of time is elapsed after input of the power supply command, the laundry treating apparatus may not create the first lighting pattern representing input of the power supply command any more but may create a second lighting pattern representing a course from that time. At this time, the laundry treating apparatus may selectively turn on or off only the course LEDs 65-71 and 74-80 while keeping all of the non-course LEDs 61-64, 72, and 73 turned off. From that time, the laundry treating apparatus may create a second lighting pattern representing a course by only the course LEDs 65-71 and 74-80.

The plurality of LEDs 60 may be arranged such that the non-course LEDs 61-64, 72, and 73 and the course LEDs 65-71 and 74-80 are sequentially disposed along an imaginary circle O.

The window 82 allows light to pass therethrough. The window 82 may be a display window for displaying information of the laundry treating apparatus. The window 82 may have an annular shape. Light emitted from the LEDs may be radiated to the window 82, and a user may check information of the laundry treating apparatus by viewing the window 82. The window 82 may be at least partially disposed between a circumference of the rotary knob hole 22 and an outer surface of the rotary knob 50. When the laundry treating apparatus further includes the knob decorative member 56, the window 82 may be at least partially disposed between the circumference of the rotary knob hole 22 and the outer surface of the rotary knob 50 and thus may be exposed to the outside. Light emitted from the LEDs may be exposed to the outside through the exposed portion of the window 82. The exposed portion of the window 82 may have an annular shape.

The laundry treating apparatus may further include a light guide 90 for protecting the plurality of LEDs 60 and guiding light emitted to the window 82 from the LEDs. The light guide 90 may mounted on the PCB 21A by means of a holding element such as a hook.

The light guide 90 may include an inner wall 92 and an outer wall 94 with an annular space defined therebetween. The plurality of LEDs 60 may be circumferentially disposed in the annular space to be spaced apart from one another. The light guide 90 may further include at least one rib that divides the annular space into a plurality of cells. The rib may be formed to be connected between the inner wall 92 and the outer wall 94. The light guide 90 may include a plurality of cells defined by a plurality of ribs. Each of the plurality of LEDs 60 may be disposed in one of the plurality of cells. Light emitted from the LEDs may pass through the cells and may be radiated to the window 82.

Hereinafter, the plurality of LEDs 60 and the window 82 will be described in detail with reference to FIGS. 2 and 6.

As illustrated in FIG. 6, the plurality of LEDs 60 may include first LED groups E and F and second LED groups G and H.

Each of the first LED groups E and F may include at least one LED for radiating light to each of indicating regions A and B of the window 82 that correspond to the indicators 23-29 and 33-39, respectively.

Each of second LED groups G and H may include at least one LED for radiating light to each of the other indicating regions C and D of the window 82. The other indicating regions C and D of the window 82 may be non-indicating regions C and D of the window 82 that do not correspond to the indicators 23-29 and 33-39.

The indicating regions A and B and the non-indicating region C and D are now described with reference to FIG. 2. The indicating regions A and B may be partial regions of the window 82, and the non-indicating regions C and D may be the regions e window 82 other than the indicating regions A and B.

The indicating regions A and B may be partial regions of the window 82 that face, among regions around the rotary knob hole 22 of the control panel body 20, regions at which the indicators 23-29 and 33-39 are positioned.

The non-indicating regions C and D may be the other remaining regions of the window 82 that face, among regions around the rotary knob hole 22 of the control panel body 20, regions at which the indicators 23-29 and 33-39 are not positioned.

When the left indicators 23-29 are positioned on the left side around the rotary knob hole 22, a region of the window 82 spanning from a region adjacent to the uppermost indicator 23 of the left indicators 23-29 to a region adjacent to the lowermost indicator 29 of the left indicators 23-29 may be referred to as a left indicating region A.

When the right indicators 33-39 are positioned on the right side around the rotary knob hole 22, a region of the window 82 spanning from a region adjacent to the uppermost indicator 33 of the right indicators 33-39 to a region adjacent to the lowermost indicator 39 of the right indicators 33-39 may be referred to as a right indicating region B.

The non-indicating regions C and D may include the upper non-indicating region C of the window 82 that is positioned between an upper end of the left indicating region A and an upper end of the right indicating region B.

The non-indicating regions C and D may include the lower non-indicating region D of the window 82 that is positioned between a lower end of the left indicating region A and a lower end of the right indicating region B.

The first LED groups E and F and the second LED groups G and H may be alternately arranged on the PCB 21A around the rotating central shaft 47 of the rotary knob 50 in a clockwise or counterclockwise direction. Referring to FIG. 6, the first LED groups E and F and the second LED groups G and H may be arranged along the imaginary circle O at which the plurality of LEDs are positioned such that the first LED group E, the second LED group H, the first LED group F and the second LED group G are positioned in this order in the clockwise direction. Conversely, the first LED groups E and F and the second LED groups G and H may be arranged along the imaginary circle 0 at which the plurality of LEDs are positioned such that the first LED group E, the second LED group G, the first LED group F and the second LED group H are positioned in this order in the counterclockwise direction.

The first LED groups E and F may include a plurality of LED groups positioned spaced apart from each other at the right and left sides. The first LED group E and F may include the first left LED group E for emitting light to a left region of the window 82 positioned at the left side of the rotary knob 50, and the first right LED group F for emitting light to a right region of the window 82 positioned at the right side of the rotary knob 50.

The first left LED group E may include at least one LED capable of emitting light to the left indicating region A of the window 82. The first right LED group F may include at least one LED capable of emitting light to the right indicating region B of the window 82.

The second LED groups G and H may include a plurality of LED groups positioned vertically spaced apart from each other. The second LED group G and H may include the second upper LED group G for emitting light to an upper region of the window 82 positioned above the rotary knob 50, and the second lower LED group H for emitting light to a lower region of the window 82 positioned below the rotary knob 50.

The second upper LED group G may include at least one LED capable of emitting light to the upper non-indicating region C of the window 82. The second lower LED group H may include at least one LED capable of emitting light to the lower non-indicating region D of the window 82.

Referring to FIG. 6, the plurality of LEDs 60 may be arranged along the imaginary circle O such that the first left LED group E, the second lower LED group H, the first right LED group F and the second upper LED group G are positioned in this order in the clockwise direction. Conversely, the plurality of LEDs 60 may be arranged along the imaginary circle O such that the first left LED group E, the second upper LED group G, the first right LED group F and the second lower LED group H are positioned in this order in the counterclockwise direction.

The first LED groups E and F may include the course LEDs 65-71 and 74-80, and the second LED groups G and H may include the non-course LEDs 61-64, 72, and 73.

Upon input of a power supply command, the first LED groups E and F may create the first lighting pattern together with the second LED groups G and H.

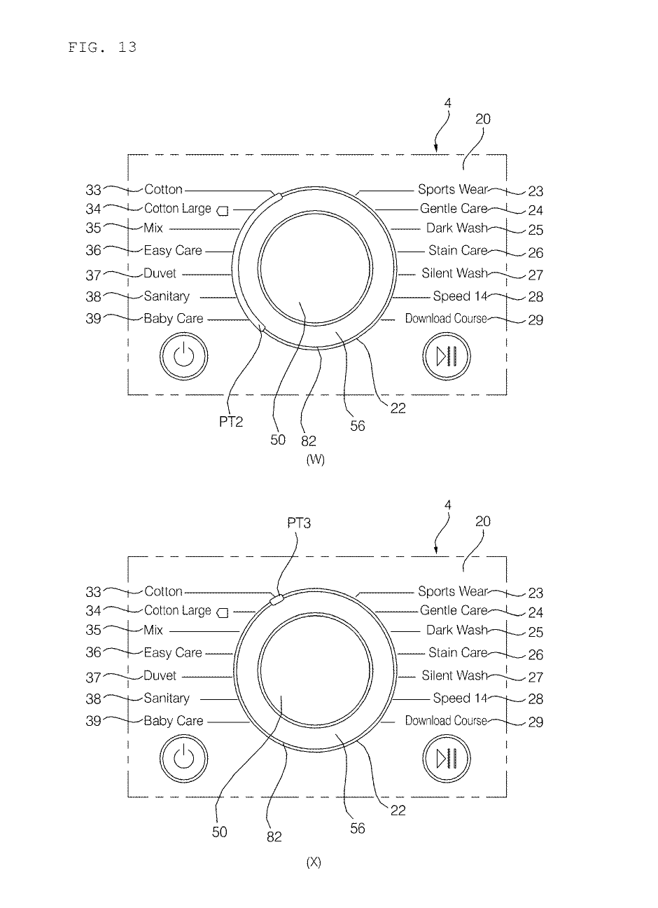

As illustrated in FIG. 11, the first lighting pattern may include a lighting pattern configured such that an arcuate lighting pattern PT2 is first created and the arcuate lighting pattern PT2 rotates around the rotary knob 50. As illustrated in FIG. 13, the first lighting pattern may further include a lighting pattern configured such that the arcuate lighting pattern PT2 rotating around the rotary knob 50 is gradually reduced in size at a specific position. As illustrated in FIG. 13, the first lighting pattern may further include a lighting pattern configured such that the reduced lighting pattern maintains a predetermined size at a specific position. As illustrated in FIGS. 11 and 13, the first lighting pattern may be a variable lighting pattern configured such that a lighting pattern gradually varying in size and position maintains a lighting pattern having the reduced size at a specific position. The first lighting pattern may be a variable lighting pattern that utilizes both the indicating regions A and B and the non-indicating regions C and D of the window 82.

Among the first LED groups E and F, only the LEDs corresponding to a predetermined course after creation of the first lighting pattern may be maintained in an on state. When the rotary knob 50 is rotated to select a course, a plurality of LEDs of the first LED groups E and F may be selectively turned on. The second LED groups G and H may be maintained in an off state after creation of the first lighting pattern. When the rotary knob 50 is rotated to select a course, the second LED groups G and H may be maintained in an off state.

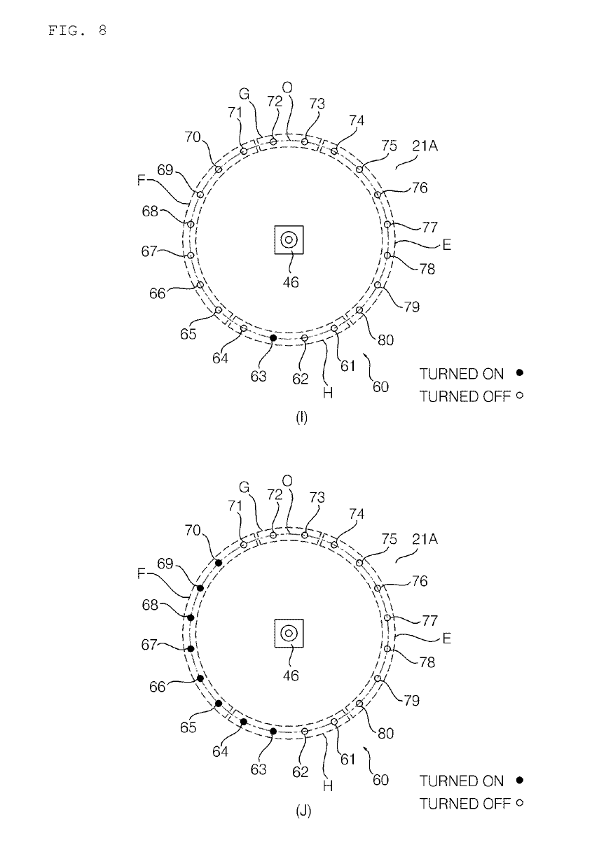

FIG. 7 illustrates an example method of controlling a laundry treating apparatus.

As illustrated in FIG. 7, the method of controlling the laundry treating apparatus may include initial operations S1, S2, S3, S4, S5 and S6 of creating a first lighting pattern and course display operations S7 and S8 of creating a second lighting pattern.

When a power supply command is input, the initial operations S1, S2, S3, S4, S5 and S6 may create the first lighting pattern configured such that a plurality of LEDs 60 that have a larger number than that of the plurality of indicators 23-29 and 33-39 formed at the control panel body 20 and are arranged in a circular shape represent the power input. The first lighting pattern may include a lighting pattern configured such that the arcuate lighting pattern PT2 rotates around the rotary knob 50.

Hereinafter, the initial operations S1, S2, S3, S4, S5 and S6 will be described in detail.

When a power supply command is input, the initial operations S1, S2, S3, S4, S5 and S6 may be initiated. A user may input a power supply command through a power key provided at the control panel 4. When the power supply command is input to the laundry treating apparatus through the power key, the laundry treating apparatus may be controlled to perform the initial operations S1, S2, S3, S4, S5 and S6.

When the power supply command is input, the method of controlling the laundry treating apparatus may include a first procedure S1 and S2 in which some LEDs 63-71 of the plurality of LEDs are sequentially turned on in the clockwise or counterclockwise direction to create the arcuate lighting pattern PT2 around the rotary knob 50.

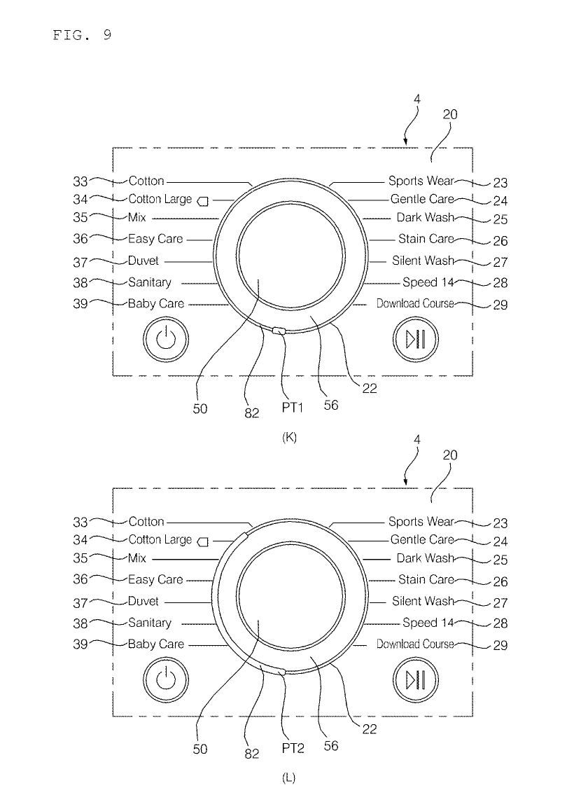

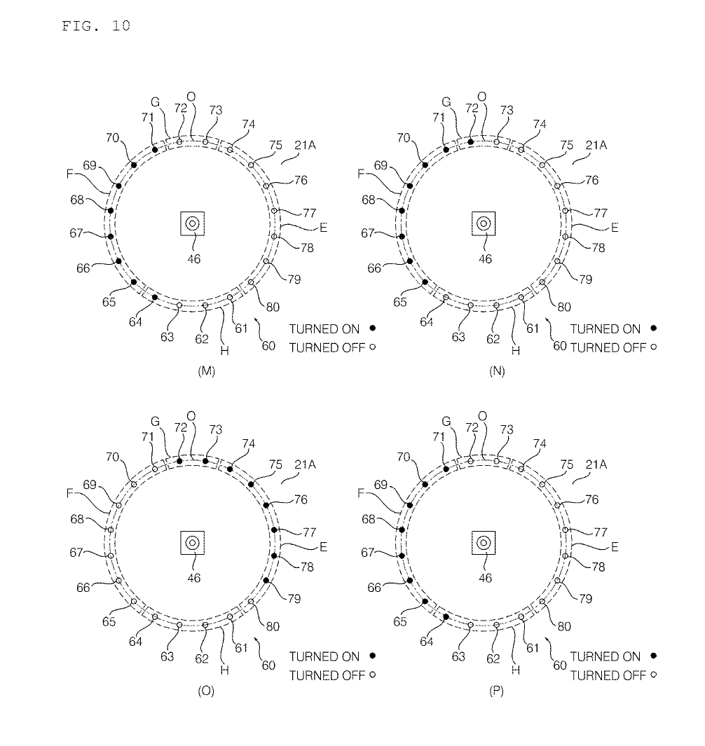

FIG. 8 illustrates an example of a plurality of LEDs when a laundry treating apparatus performs a procedure and displays a lighting pattern. FIG. 9 illustrates an example control panel when a laundry treating apparatus performs a procedure and displays a lighting pattern.

In the first procedure of the first lighting pattern, the plurality of LEDs 60 may be controlled to create the arcuate lighting pattern PT2 with time.

FIG. 8(I) illustrates a case in which a predetermined reference LED 63 of the plurality of LEDs 60 is turned on first. FIG. 9(K) illustrates the control panel 4 when the one predetermined reference LED 63 is turned on as illustrated in FIG. 8(I). In this case, the reference LED 63 may be a first predetermined LED configured to be turned on first in the first lighting pattern.

When the reference LED 63 is turned on, the area of the window 82 that corresponds to the reference LED 63 may be brightly irradiated. At this time, a small lighting pattern PT1 having a shape similar to a rectangular or circular shape may be created as illustrated in FIG. 9(K).

FIG. 8(J) illustrates a case in which a predetermined number of LEDs 63-70 of the plurality of LEDs 60 are sequentially turned on. FIG. 9(L) illustrates the control panel 4 when the predetermined number of LEDs 63 are sequentially turned on as illustrated in FIG. 8(J).

The plurality of LEDs 60 may be turned on in such a manner that the reference LED 63 is turned on first and then the LEDs are turned on in the clockwise or counterclockwise direction with the result that the arcuate lighting pattern PT2 may be created around the rotary knob 50. The arcuate lighting pattern PT2 created on the window 82 may be increased in size as the number of lit LEDs is increased. The plurality of LEDs 60 may be turned on in such a manner that the reference LED 63 is turned on and then the LEDs are turned on in the counterclockwise direction from the reference LED 63.

LEDs adjacent to the most recently lit LED may be turned on until the number of lit LEDs of the plurality of LEDs reaches the predetermined number. When the number of lit LEDs reaches the predetermined number, the number of lit LEDs may not be increased any more.

The area of the window 82 that corresponds to the predetermined number of lit LEDs 63-70 is brightly irradiated with the result that a larger arcuate lighting pattern PT2 may be created on the window 82 as illustrated in FIG. 9(L).

The initial operations S1, S2, S3, S4, S5 and S6 may further include a second procedure S3 and S4 in which the arcuate lighting pattern PT2 rotates around the rotary knob 50. The second procedure S3 and S4 may be initiated when the number of LEDs lit in the first procedure S1 and S2 reaches the predetermined number. In the second procedure S3 and S4, the plurality of LEDs may be sequentially turned on and then turned off. In the second procedure S3 and S4, during the rotation around the rotary knob 50, the arcuate lighting pattern PT2 may have a leading end PL at which the plurality of LEDs are sequentially turned on in the clockwise or counterclockwise direction and a posterior end PM at which the plurality of LEDs are sequentially turned off in the clockwise or counterclockwise direction. The arcuate lighting pattern PT2 may gradually move around the rotary knob 50 while maintaining its own size.

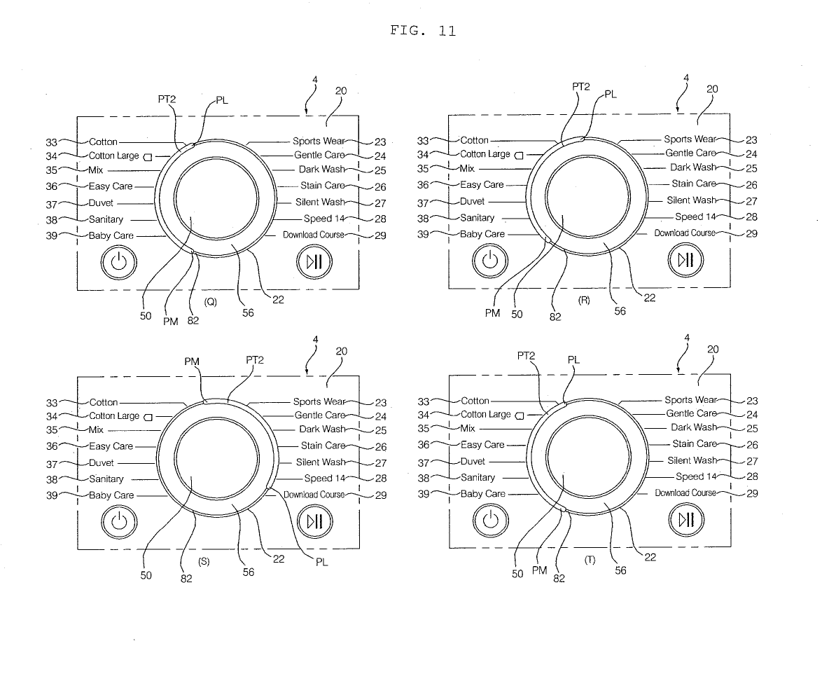

FIG. 10 illustrates an example of a plurality of LEDs when a laundry treating apparatus performs a procedure and displays a lighting pattern. FIG. 11 illustrates an example control panel when a laundry treating apparatus performs a procedure and displays a lighting pattern.

In the second procedure of the first lighting pattern, the plurality of LEDs 60 may be controlled in such a manner that the arcuate lighting pattern PT2 created in the first procedure rotates around the rotary knob 50. The arcuate lighting pattern PT2 created in the first procedure may gradually move with time while maintaining its own size.

FIG. 10(M) illustrates a case in which the LED 63 that was turned on first among the LEDs turned on in the first procedure of the first lighting pattern is turned off and the LED 71 adjacent to the LED 70 turned off last is turned on. FIG. 11(Q) is a view illustrating the control panel 4 when the plurality of LEDs 60 are turned on as illustrated in FIG. 10(M), in which the lighting pattern PT2 having the same size as that of the arcuate lighting pattern shown in FIG. 9(L) and moved around the rotary knob 50 by a predetermined angle may be created on the window 82.

In the second procedure of the first lighting pattern, the plurality of LEDs 60 may be sequentially turned on in the clockwise or counterclockwise while being sequentially turned off in the clockwise or counterclockwise direction with time.

FIG. 10(N) illustrates a case in which the LED 72 adjacent to the LED 71 that was turned off last is turned on among the currently lit LEDs and the LED 64 that was turned on first among the currently lit LEDs is turned off. FIG. 11(R) is a view illustrating the control panel 4 when the plurality of LEDs 60 are turned on as illustrated in FIG. 10(N), in which the lighting pattern PT2 having the same size as that of the arcuate lighting pattern shown in FIG. 11(Q) and moved around the rotary knob 50 by a predetermined angle may be created on the window 82.

The plurality of LEDs 60 may be controlled in such a manner that, when the LED nearest the LED that was turned on last among the currently lit LEDs is turned on, the LED that was turned on first among the currently lit LEDs is turned off. The plurality of LEDs 60 may create a variable lighting pattern that rotates around the rotary knob 50 while maintaining the size of the arcuate lighting pattern PT2. The plurality of LEDs 60 are repeatedly turned on and turned off with time in the above-described manner.

FIG. 10(O) illustrates a case in which a procedure configured such that the LED nearest the LED that was turned on last among the currently lit LEDs is turned on and the LED that was turned on first among the currently lit LEDs is turned off is performed several times. FIG. 11(S) is view illustrating the control panel 4 in which the plurality of LEDs 60 are turned on as illustrated in FIG. 10(O), in which the lighting pattern PT2 having the same size as that of the arcuate lighting pattern shown in FIG. 11(R) and moved around the rotary knob 50 may be created on the window 82.

When the LED nearest the LED that was turned on last among the currently lit LEDs is turned on after the predetermined LED 71 is turned on predetermined number of times, it is possible to prevent the LED that was turned on first among the currently lit LEDs from being turned off. The predetermined LED 71 may be a second predetermined LED that is previously determined. The predetermined number of times may be twice or more. This is because the arcuate lighting pattern PT2 may not rotate one turn or more around the rotary knob 50 if the predetermined number of times is once.

FIG. 10(P) illustrates a case in which the predetermined LED 71 of the plurality of LEDs 60 is turned on the predetermined number of times. FIG. 11(T) is a view illustrating the control panel 4 when the plurality of LEDs 60 are turned on as illustrated in FIG. 10(P), in which the lighting pattern PT2 having the same size as that of the arcuate lighting pattern shown in FIG. 11(S) and moved to the position corresponding to the predetermined LED 71 may be created on the window 82.

The initial operations S1, S2, S3, S4, S5, and S6 may further include a third procedure S5 and S6 in which, when the predetermined LED 71 of the plurality of LEDs 60 is turned on the predetermined number of times (for example, twice), the LEDs other than the predetermined LED 71 among the currently lit LEDs are sequentially turned off.

When the predetermined LED 71 is turned on the predetermined number of times, the third procedure S5 and S6 may be initiated. The third procedure S5 and S6 may be under the condition that only the predetermined LED 71 is turned on. When a course selection command is not input by a user, the state that the predetermined LED 71 is turned on may be maintained.

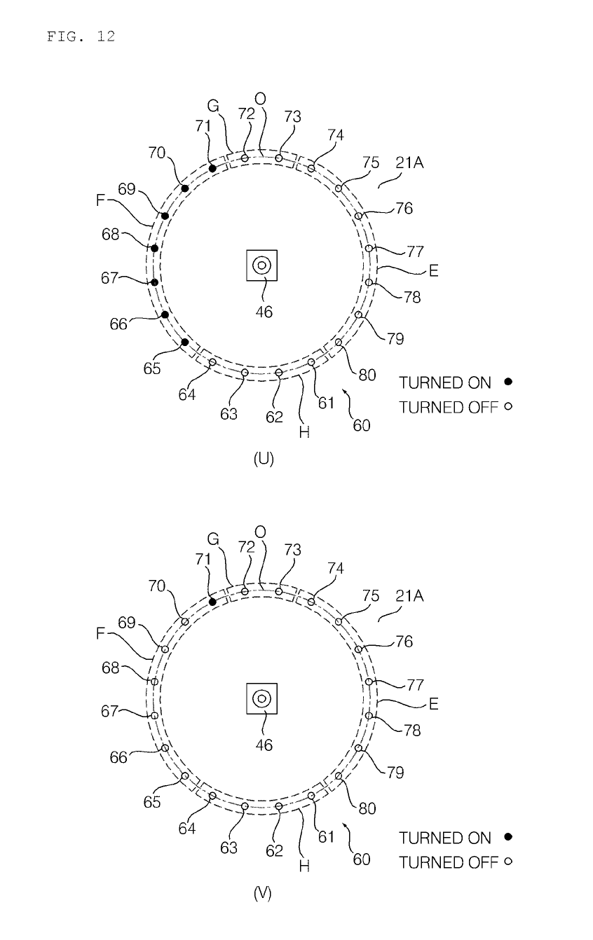

FIG. 12 illustrates an example of a plurality of LEDs when a laundry treating apparatus performs a procedure and displays a lighting pattern. FIG. 13 illustrates an example control panel when a treating apparatus performs a procedure and displays a lighting pattern.

In the third procedure of the first lighting pattern, the plurality of LEDs 60 may be controlled in such a manner that the arcuate lighting pattern PT2 rotating around the rotary knob 50 is gradually decreased in size at a specific position and the reduced lighting pattern maintains a predetermined size and is held at a specific position.

FIG. 12(U) illustrates a case in which, when the predetermined LED 71 of the plurality of LEDs 60 is turned on the predetermined number of times, the LED 64 that was turned on first among the lit LEDs is turned off. FIG. 13(W) is a view illustrating the control panel 4 when the plurality of LEDs are turned on as illustrated in FIG. 12(U), in which the lighting pattern PT2 smaller than that of the arcuate lighting pattern shown in FIG. 11(T) may be created on the window 82.

In the third procedure of the first lighting pattern, the plurality of LEDs 60 may be controlled in such a manner that the LEDs other than the predetermined LED 71 among the currently lit LEDs are sequentially turned off and the LEDs other than the predetermined LED 71 are sequentially turned off in the order that the LEDs were turned on.

FIG. 12(V) illustrates a case in which only the predetermined LED 71 of the plurality of LEDs 60 is turned on whereas all of the other LEDs are turned off. FIG. 13(X) is a view illustrating the control panel 4 when only the predetermined LED 71 is turned on, in which the lighting pattern PT3 smaller than that of the arcuate lighting pattern shown in FIG. 13(W) may be created on the window 82.

In the first lighting pattern, the plurality of LEDs 60 may be turned on and turned off in the order shown in FIGS. 8, 10 and 12, and the plurality of LEDs 60 may create the lighting pattern that moves in the order shown in FIGS. 9, 11 and 13. Thereafter, only the predetermined LED 71 may be maintained in an on state until a user rotates the rotary knob 50.

The initial operations S1, S2, S3, S4, S5, and S6 may be completed when the rotary knob 50 is rotated under the condition that the predetermined LED 71 is turned on. At this time, the method of controlling the laundry treating apparatus may initiate course display operations S7 and S8.

In the course display operations S7 and S8, when a course selection command is input, some LEDs 65-71 and 74-80 of the plurality of LEDs 60 which radiate light toward the indicating regions A and B may be selectively turned on to create the second lighting pattern and the remaining LEDs 61-64, 72, and 73 for radiating light toward the regions C and D other than the indicating regions may be turned off.

When the rotary knob 50 is rotated under the condition that the predetermined LED 71 is turned on, the some LEDs 65-71 and 74-80 of the plurality of LEDs 60 that radiate light toward the indicating regions A and B may be turned on and turned off by rotation of the rotary knob 50.

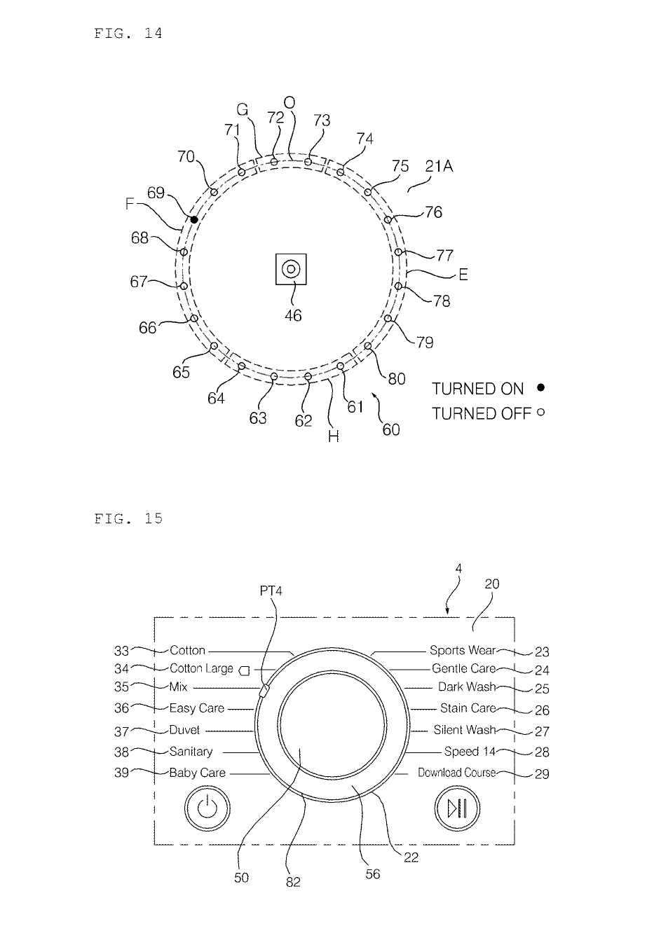

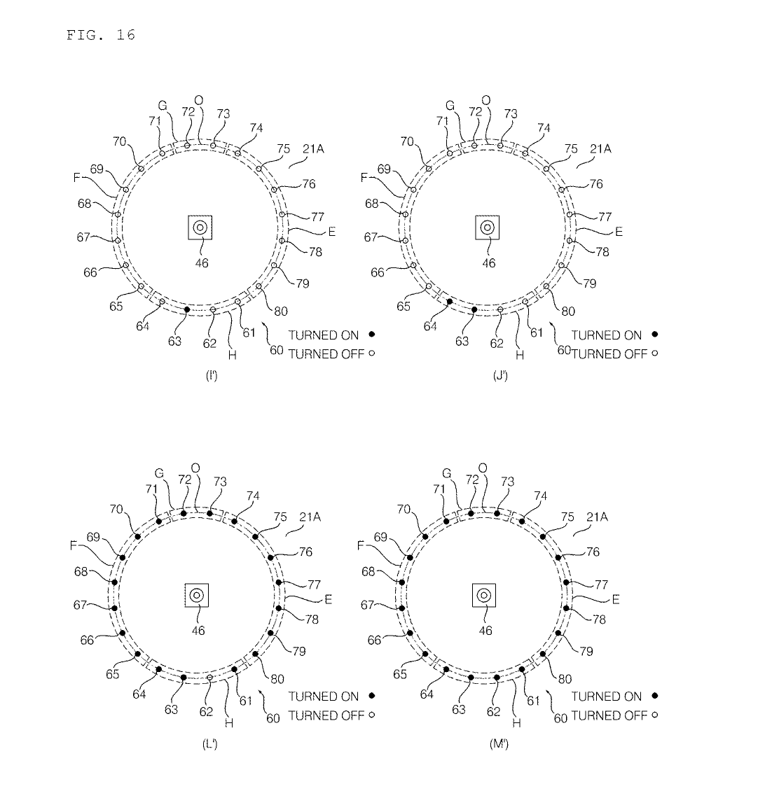

Hereinafter, the second lighting pattern will be described with reference to FIGS. 14 and 15.

FIG. 14 illustrates an example of a plurality of LEDs when a laundry treating apparatus creates a lighting pattern. FIG. 15 illustrates an example control panel when a laundry treating apparatus creates a lighting pattern.

A user may select a specific course by rotating the rotary knob 50 by a predetermined angle under the condition that only the predetermined LED 71 is turned on.

At this time, the predetermined LED 71 turned on as shown in FIG. 12(V) may be turned off as shown in FIG. 14, and the LED 69 corresponding to a course selected by a user may be turned on. FIG. 15 is a view illustrating the control panel 4 when the predetermined LED 71 is turned off whereas the LED 69 corresponding to the course selected by a user is turned on. At this time, a lighting pattern PT4 having the same size as the lighting pattern PT3 and having a position different from the lighting pattern PT3 under the condition that only the predetermined LED 71 is turned on may be created on the window 82.

As illustrated in FIG. 7, when an operation command is input during the course display operations S7 and S8, the laundry treating apparatus may be operated in the course selected by a user (S10 and S11). A user may input an operation command through an operation key provided at the control panel during the course display operations S7 and S8, and the laundry treating apparatus may be operated in the selected course for a period of time determined in accordance with the selected course.

After the selected course is performed for the predetermined period of time, the method may complete the operation in the course (S11). The method may turn off the LED 69 turned on at the time that a course is selected by rotation of the rotary knob 50 (S12).

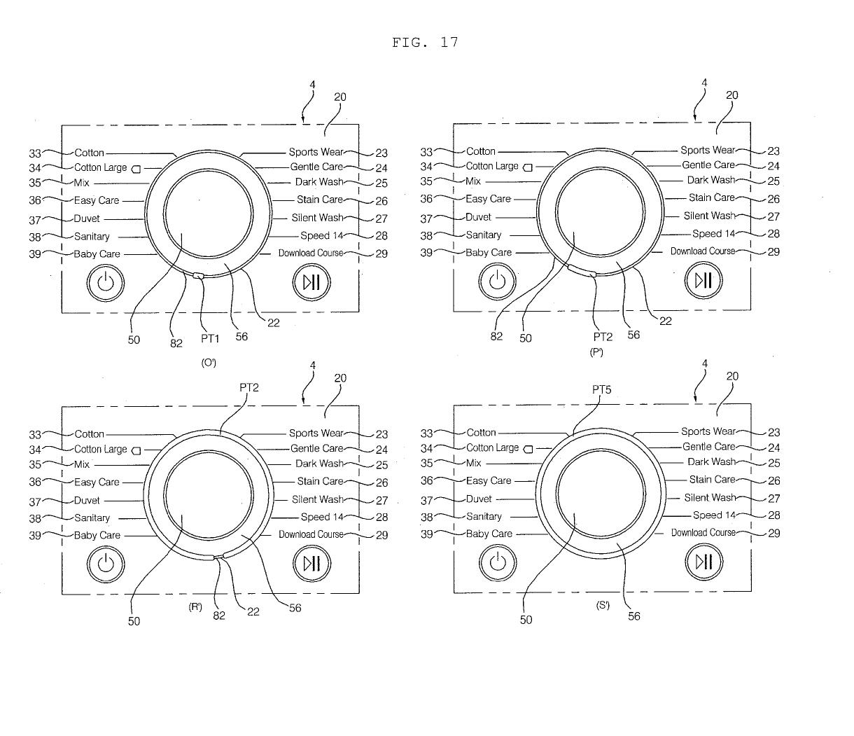

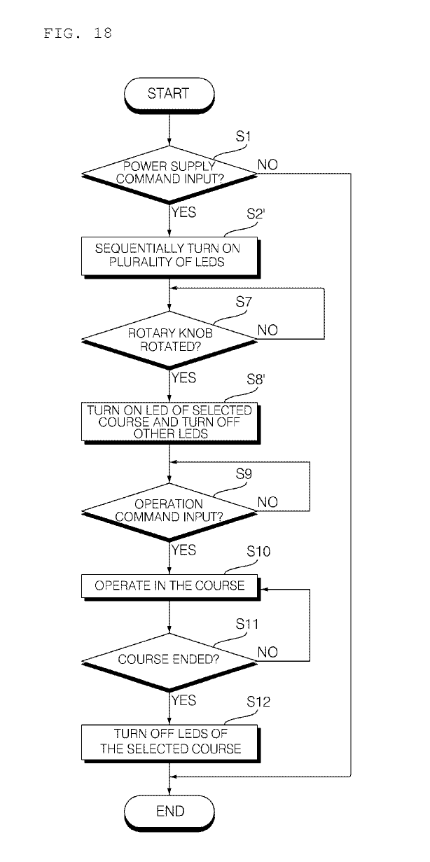

FIG. 16 illustrates an example of a plurality of LEDs when a power supply command is input to a laundry treating apparatus. FIG. 17 illustrates example lighting patterns created on a control panel when a power supply command is input to a laundry treating apparatus. FIG. 18 is a flowchart of an example method of controlling a laundry treating apparatus.

In some implementations, when a power supply command is input to the laundry treating apparatus, the plurality of LEDs 60 may be sequentially turned on in the clockwise or counterclockwise direction. Among the plurality of LEDs 60, the reference LED 63 may be turned on first, and then the remaining LEDs 64-80, 61, and 62 that are currently turned off may be turned on. As illustrated in FIG. 16, all of the LEDs 64-80, 61, and 62 turned on after turning on of the reference LED 63 may be sequentially turned on in the clockwise or counterclockwise direction. In some implementations, when a power supply command is input to the laundry treating apparatus, all of the LEDs 60 may be turned on.

FIG. 16(I′) illustrates a case in which the reference LED 63 is turned on after input of a power supply command. FIG. 17(O′) illustrates a case in which a small lighting pattern PT1 having a shape similar to a rectangular or circular shape at the time that the reference LED 63 is turned on is created on the window 82.

FIG. 16(J′) illustrates a case in which the LED 64 nearest the lighting reference LED 63 in a clockwise or counterclockwise direction is turned on after turning on of the reference LED 63. FIG. 17(P′) illustrates a case in which a lighting pattern PT2 larger than the lighting pattern PT1 shown in FIG. 17(O′) is created on the window 82 at the time that the LED 64 nearest the reference LED 63 is turned on.

FIG. 16(L′) illustrates a case in which the sequential turning on of the plurality of LEDs is further performed several times. FIG. 17(R′) illustrates a case in which a lighting pattern PT2 larger than the lighting pattern shown in FIG. 17(P′) is created on the window 82.

FIG. 16(M′) illustrates a case in which all of the plurality of LEDs 60 are sequentially turned on. FIG. 17(S′) illustrates a case in which an annular lighting pattern PT5 is created on the window 82.

As the plurality of LEDs 60 are sequentially turned on, the lighting pattern created on the window 82 may be gradually increased in size and may have a shape that is changed in the order of a circular shape, an arcuate shape and an annular shape, as illustrated in FIG. 17.

In some implementations, a course selection command may be input after all of the plurality of LEDs 60 are turned on. All of the plurality of LEDs 60 may be maintained in an on state until rotation of the rotary knob 50 is detected.

In some implementations, when a user rotates the rotary knob 50, only the LED corresponding to the course selected by the user may be turned on whereas all of the remaining LEDs may be turned off.

Referring to FIG. 18, the method may include initial operations S1 and S2′ and course display operations S7 and S8′. As illustrated in FIG. 16, the plurality of LEDs 60 may be sequentially turned on in the clockwise or counterclockwise direction in the initial operations S1 and S2′. As illustrated in FIG. 17, the lighting pattern which is gradually increased in size and has a shape changing in the order of a circular shape, an arcuate shape and an annular shape may be created on the window 82.

Similarly to the course display operations S7 and S8, the course display operations S7 and S8′ may be configured such that, by input of a course selection command, some LEDs 65-71 and 74-80 of the plurality of LEDs 60 which radiate light to the indicating regions A and B are selectively turned on to create the second lighting pattern whereas the remaining LEDs 61-64, 72, and 73 radiating light to the regions C and D excluding the indicating regions are turned off.

The course display operations S7 and S8′ may be initiated when the rotary knob 50 is manipulated under the condition that all of the plurality of LEDs 60 are turned on. When the rotary knob 50 is manipulated under the condition that all of the plurality of LEDs 60 are turned on, the LED of the plurality of LEDs 60, that corresponds to a course selected by a user, may be turned on and all of the other LEDs may be turned off.

In some implementations, since operations S9, S10, S11 and S12 other than the initial operation S1 and S2′ and the course display operations S7 and S8 may be identical or similar to those of other implementations, the corresponding components are denoted by the same numerals and a detailed description thereof is omitted.

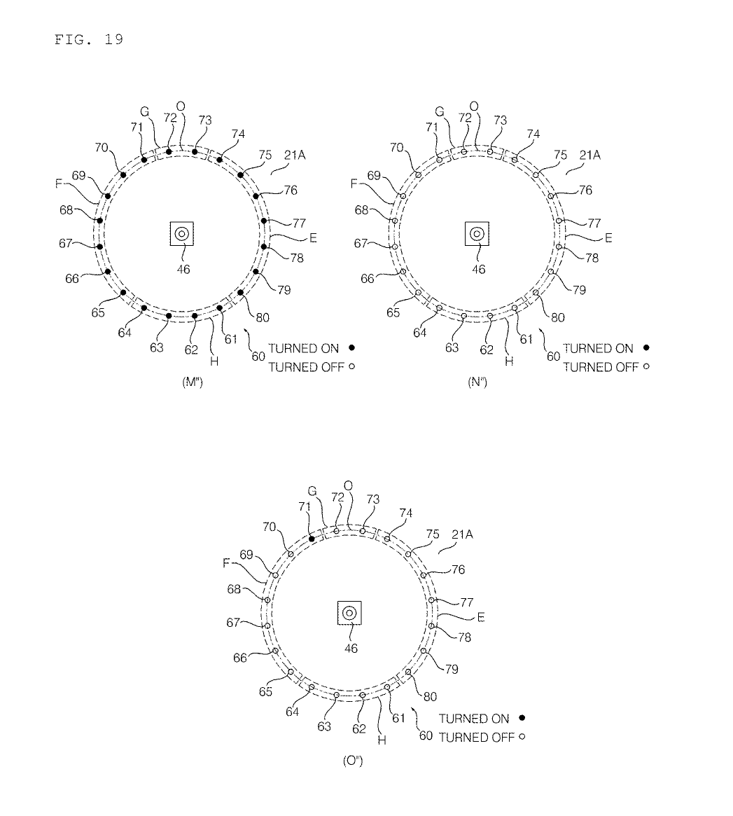

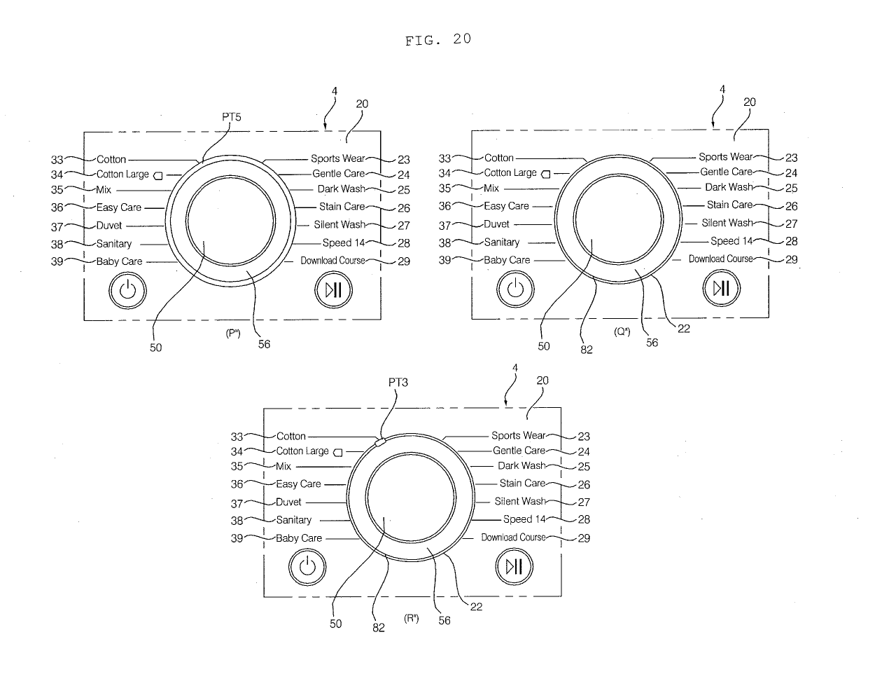

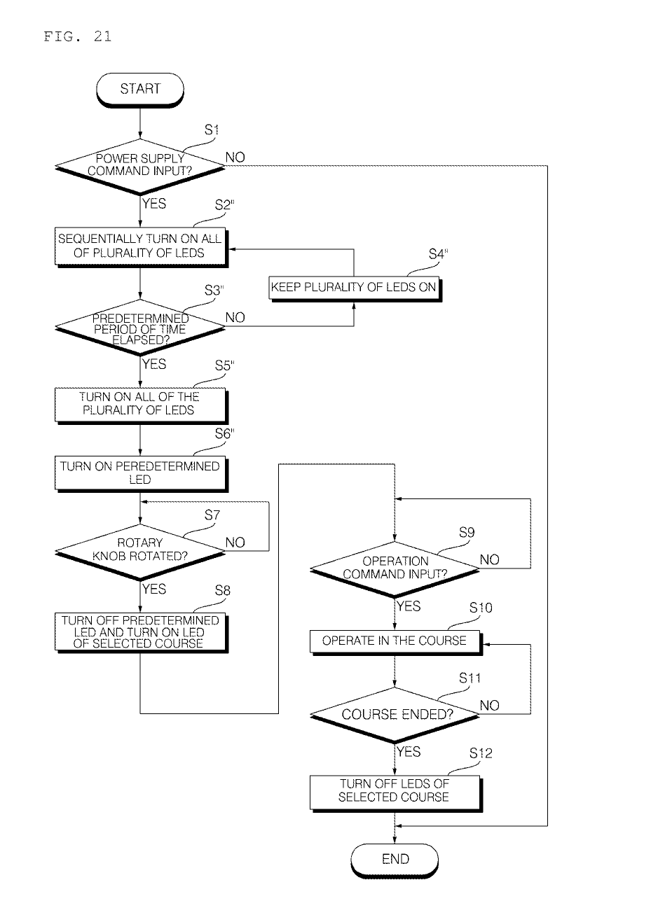

FIG. 19 illustrates an example of a plurality of LEDs when a power supply command is input to a laundry treating apparatus. FIG. 20 illustrates an example lighting pattern created on a window when a power supply command is input to a laundry treating apparatus. FIG. 21 is a flowchart of an example method of controlling a laundry treating apparatus.

In some implementations, when a power supply command is input to the laundry treating apparatus, the plurality of LEDs 60 may be sequentially turned on in the clockwise or counterclockwise direction. The plurality of LEDs 60 may be maintained in an on state for a predetermined period of time after all of the plurality of LEDs 60 are turned on. After lapse of the predetermined period of time, all of the plurality of LEDs 60 may be turned off. After all of the plurality of LEDs 60 are turned off, only the predetermined LED 71 may be turned on.

In some implementations, since the laundry treating apparatus may be identical or similar to other implementations of the laundry treating apparatus in construction and function, aside from the manner of turning on and off the plurality of LEDs 60, a detailed description thereof is omitted.

FIG. 19(M″) illustrates a case in which all of the plurality of LEDs 60 are sequentially turned on in the clockwise or counterclockwise direction from the reference LED 63 after a power supply command is input. FIG. 20(P″) illustrates a case in which an annular lighting pattern PT5 is created on the window 82 by turning on the plurality of LEDs 60 as shown in FIG. 19(M″). After all of the plurality of LEDs 60 are turned on, the plurality of LEDs 60 may be maintained in an on state for a predetermined period of time (for example, 0.5 seconds).

FIG. 19(N″) illustrates a case in which all of the plurality of LEDs 60 are turned off after lapse of the predetermined period of time (for example, 0.5 seconds). FIG. 20(Q″) illustrates a case in which a lighting pattern is not created on the window 82 by turning off the plurality of LEDs 60 as shown in FIG. 19(N″).

FIG. 19(O″) illustrates a case in which only the predetermined LED 71 is turned on after the plurality of LEDs 60 are turned off. FIG. 20(R″) illustrates a case in which a small lighting pattern PT3 having a shape similar to a rectangular or circular shape is created in an area of the window 82 corresponding to the predetermined LED 71.

In some implementations, the method of controlling the laundry treating apparatus may include initial operations S1, S2″, S3″, S4″, S5″ and S6″ and course display operations S7 and S8. The initial operations S1, S2″, S3″, S4″, S5″, and S6″ may include a first procedure S1 and S2″ in which the plurality of LEDs 60 are sequentially turned on in the clockwise or counterclockwise direction.

In the first procedure S1 and S2″, the plurality of LEDs 60 may be sequentially turned on starting from the reference LED 63, and all of the plurality of LEDs 60 may be turned on as illustrated in FIG. 19(M″). At this time, an annular lighting pattern PT5 may be created on the window 82.

The initial operations S1, S2″, S3″, S4″, S5″, and S6″ may include a second procedure S3″ and S4″ in which, after all of the plurality of LEDs 60 are turned on, the plurality of LEDs are maintained in an on state for a predetermined period of time. In the second procedure S3″ and S4″, after the LED 62 among the plurality of LEDs 60 is turned on last in the first procedure S1 and S2″, all of the plurality of LEDs 60 may be maintained in an on state for the predetermined period of time.

The initial operations S1, S2″, S3″, S4″, S5″, and S6″ may further include a third procedure S5″ in which all of the plurality of LEDs are turned off after lapse of the predetermined period of time. In the third procedure, all of the plurality of LEDs 60 may be turned off as illustrated in FIG. 19(M″). At this time, a lighting pattern may not be created on the window 82.

The initial operations S1, S2″, S3″, S4″, S5″, and S6″ may further include a fourth procedure S6″ in which the predetermined LED 71 is turned on. In the fourth procedure S6″, only the predetermined LED 71 of the plurality of LEDs 60 is turned on as illustrated in FIG. 19(O″). At this time, a small lighting pattern PT3 having a shape similar to a rectangular or circular shape may be created on the area of the window 8 corresponding to the predetermined LED 71.

In some implementations, when the rotary knob 50 is rotated under the condition that the predetermined LED 71 is turned on, the course display operations S7 and S8 may be initiated.

In some implementations, the method of controlling the laundry treating apparatus may be identical or similar other implementations of the method in operations S7, S8, S9, S10, S11 and S12 other than the initial operations S1, S2″, S3″, S4″, S5″, and S6″ and in function thereof, the corresponding components are denoted by the same numerals and a detailed description thereof is omitted.

What is claimed is:

1. A laundry treating apparatus comprising:
a rotary control;
a control panel body that includes:
a rotary control hole in which the rotary control is rotatably positioned, and
at least one indicator configured to indicate a course capable of being selected by the rotary control;
a plurality of light emitting diodes (LEDs) arranged on a printed circuit board (PCB), a number of the plurality of LEDs being larger than a number of the at least one indicator; and
a window through which light emitted from the plurality of LEDs passes,
wherein the plurality of LEDs comprises:
a first LED group including at least one LED that is configured to radiate light to an indicating region of the window corresponding to the at least one indicator, and
a second LED group including at least one LED that is configured to radiate light to a region of the window that is outside of the indicating region of the window.

2. The laundry treating apparatus according to claim 1, wherein the plurality of LEDs are spaced apart from each other at regular intervals in a circular pattern.

3. The laundry treating apparatus according to claim 1, wherein the rotary control is a rotary knob and wherein the first LED group and the second LED group are alternately located on the PCB in a clockwise or counterclockwise direction about a rotating central shaft of the rotary knob.

4. The laundry treating apparatus according to claim 1, wherein the first LED group comprises:
a first left LED group that is configured to radiate light to a left region of the window located at a left side of the rotary control; and
a first right LED group that is configured to radiate light to a right region of the window located at a right side of the rotary control,
wherein the second LED group comprises:
a second upper LED group that is configured to radiate light to an upper region of the window located above the rotary control, and
a second lower LED group that is configured to radiate light to a lower region of the window located below the rotary control.

5. The laundry treating apparatus according to claim 1, wherein the first LED group and the second LED group radiate light in a first lighting pattern in response to a power supply command being input.

6. The laundry treating apparatus according to claim 5, wherein the second LED group is maintained in an off state after radiating light in the first lighting pattern.

7. The laundry treating apparatus according to claim 5, wherein only an LED of the first LED group corresponding to a predetermined course is maintained in an on state after radiating light in the first lighting pattern.

8. The laundry treating apparatus according to claim 1, wherein the second LED group is maintained in an off state during rotation of the rotary control.

9. The laundry treating apparatus according to claim 1, wherein a plurality of LEDs of the first LED group are selectively turned on during rotation of the rotary control.

10. The laundry treating apparatus according to claim 1, wherein the plurality of LEDs are controlled to radiate light in an arcuate lighting pattern that rotates around the rotary control in response to a power supply command being input.

11. The laundry treating apparatus according to claim 1, wherein the plurality of LEDs are sequentially turned on in a clockwise or counterclockwise direction in response to a power supply command being input.

12. The laundry treating apparatus according to claim 11, wherein the plurality of LEDs are maintained in an on state for a predetermined period of time after all of the plurality of LEDs are turned on.

13. The laundry treating apparatus according to claim 12, wherein, after the predetermined period of time has elapsed, all of the plurality of LEDs are turned off except a predetermined LED is maintained in an on state.

14. A method of controlling a laundry treating apparatus, comprising:
receiving a power supply command;
in response to receiving the power supply command, controlling a plurality of LEDs to radiate light in a first lighting pattern representing the power supply command, a number of the plurality of LEDs being larger than a number of a plurality of indicators located on a control panel body;
receiving a course selection command; and
in response to receiving the course selection command:
selectively turning on one or more LEDs of a first set of the plurality of LEDs to radiate light to an indicating region in a second lighting pattern, and
maintaining a second set of the plurality of LEDs in an off state, the second set of the plurality of LEDs are different from the first set of the plurality of LEDs and radiate light to a region other than the indicating region.

15. The method according to claim 14, wherein the first lighting pattern includes an arcuate lighting pattern rotating around a rotary control.

16. The method according to claim 14, wherein controlling the plurality of LEDs to radiate light in the first lighting pattern comprises sequentially turning on the some LEDs of the plurality of LEDs in a clockwise or counterclockwise direction to radiate light in an arcuate lighting pattern around a rotary control.

17. The method according to claim 16, further comprising:
in response to receiving the power supply command, rotating the arcuate lighting pattern around the rotary control.

18. The method according to claim 17, wherein the arcuate lighting pattern has a leading end at which the plurality of LEDs are sequentially turned on in a clockwise or counterclockwise direction and a posterior end at which the plurality of LEDs are sequentially turned off in the clockwise or counterclockwise direction.

19. The method according to claim 17, comprising maintaining a size of the arcuate lighting pattern.

20. The method according to claim 17, further comprising:
determining that a predetermined LED of the plurality of LEDs is turned on a predetermined number of times; and
based on determining that the predetermined LED is turned on the predetermined number of times, sequentially turning off the plurality of LEDs that are illuminated other than the predetermined LED.

21. The method according to claim 14, wherein controlling the plurality of LEDs to radiate light in the first lighting pattern comprises sequentially turning on the plurality of LEDs in a clockwise or counterclockwise direction.

22. The method according to claim 14, wherein controlling the plurality of LEDs to radiate light in the first lighting pattern comprises:
sequentially turning on the plurality of LEDs in a clockwise or counterclockwise direction; and
maintaining the plurality of LEDs in an activated state for a predetermined period of time after all of the plurality of LEDs have been turned on.

23. The method according to claim 22, wherein controlling the plurality of LEDs to radiate light in the first lighting pattern further comprises, after the predetermined period of time has elapsed, turning off all of the plurality of LEDs.

24. The method according to claim 23, wherein controlling the plurality of LEDs to radiate light in the first lighting pattern further comprises turning on a predetermined LED.
